(19) United States
(12) Patent Application Publication
(10) Pub. No.: US 2022/0055429 A1
(43) Pub. Date: Feb. 24, 2022

(54) CAMPER CRADLE

(71) Applicants: Thomas Dean Emmert, Enumclaw, WA (US); Scott Clayton Baker, Enumclaw, WA (US)

(72) Inventors: Thomas Dean Emmert, Enumclaw, WA (US); Scott Clayton Baker, Enumclaw, WA (US)

(21) Appl. No.: 16/995,813

(22) Filed: Aug. 18, 2020

(51) Int. Cl. B60D 1/36; B60D 1/52

(52) U.S. Cl. CPC B60D 1/36; B60D 1/52

(57) ABSTRACT

The “Camper Cradle” device is a modular assembly for most typical pickup truck beds, which mounts to the factory tailgate hinge and latch points. The assembly consists of adjustable telescoping tube steel, 3D printed/molded hinge bushings and rubber/nylon guide rollers. Said device/assembly is designed to guide and center a typical truck mounted camper into a typical pickup truck bed. It is intended to make loading a camper less difficult as it assists the driver by means of adjustable vertical rollers which capture, center and guide the camper into the bed of the pickup while backing under.

A modular centering and nestling device with a product name of “Camper Cradle” referencing said centering and nestling device. Said Camper Cradle is intended to function as part of, not independent of, most late model and some early-mid model rear pickup bed tailgate hinge and latch assemblies. Said Camper Cradle consists of three basic components: (1) The bottom horizontal and transverse structure is a three-part assembly (see FIG. 1). The halves (or sides) are fitted with a slip joint (center section) for width adjustability and fixed by means of set screws once desired placement is achieved. At the outboard end of each side is a fixed receiver tube in the vertical orientation, welded to the outboard end of each side (see FIG. 1). Also, welded within the outboard ends of the horizontal transverse structure are 2″ O.D.×1.5″ long round tube segments (typical each end). Said tube segments, along with the use of bushings, are designed to capture the factory tailgate hinge of the vehicle. (2) The vertical (or upright) stud height adjusters (see FIG. 1 & FIG. 2) slip into and reside inside the fixed vertical receiver tubes of component 1. Said stud height adjusters' function as a slip joint and are fixed by means of set screws once desired height is achieved in order to capture factory vehicle tailgate latch studs. (3) The adjustable roller assembly (see FIG. 1) 2 qty. one each located near outboard ends of horizontal/transverse structure, designed to adjust and match the standard base width of a typical truck mounted camper. Once desired width is achieved, the roller assembly position on the horizontal structure can be fixed by means of set screws (see FIG. 1).

### DRAWING DESCRIPTION

FIG. 1: Elevation view of complete modular assembly as viewed from rear of vehicle.

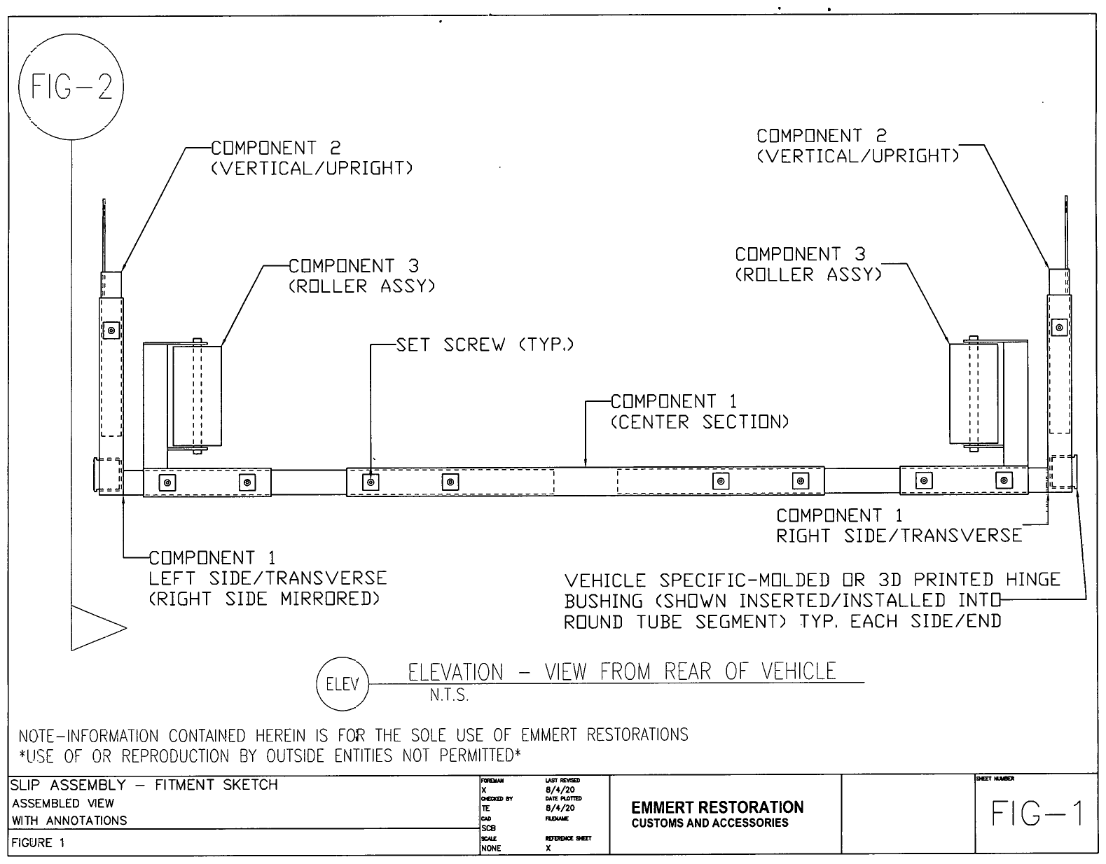

FIG. 2: Section View taken at left vertical end assembly as referenced from section callout on FIG. 1.

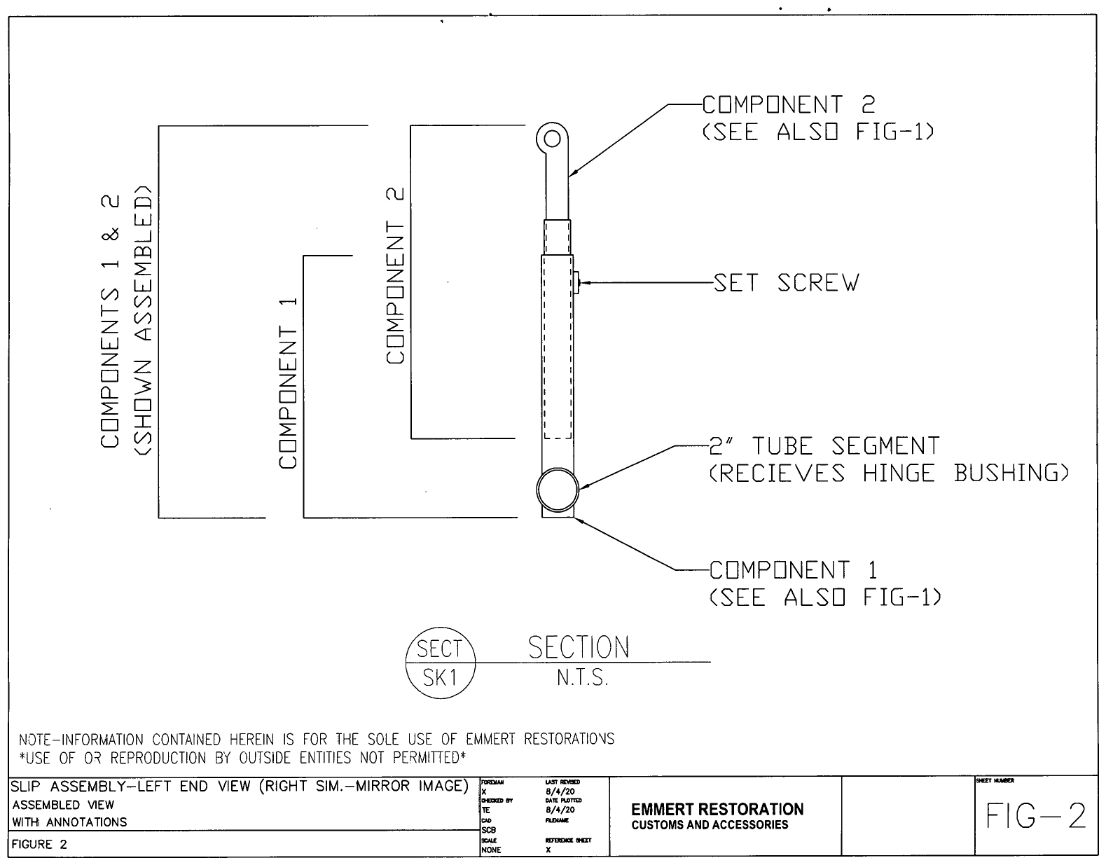

1. An automotive accessory, designed to assist the loading and centering of a typical truck mounted camper into the bed of a typical pickup truck. This is achieved by means of an adjustable and modular assembly constructed primarily from mild steel tubing and assembled telescopically with guide rollers positioned such that the camper be guided into the rear of the pickup bed.
